(19) United States
(12) Patent Application Publication
(10) Pub. No.: US 2018/0103630 A1
(43) Pub. Date: Apr. 19, 2018

(54) FLY FISHING RIG HOLDER AND METHOD FOR HOLDING FLY FISHING RIGS

(71) Applicants: Joshua J. Huber, Montrose, CO (US); Justin J. Stratman, Montrose, CO (US)

(72) Inventors: Joshua J. Huber, Montrose, CO (US); Justin J. Stratman, Montrose, CO (US)

(21) Appl. No.: 15/292,502

(22) Filed: Oct. 13, 2016

(51) Int. Cl. A01K 97/06; A01K 85/08

(52) U.S. Cl. CPC A01K 97/06; A01K 85/08

(57) ABSTRACT

A highly advantageous fly fishing rig holder with interchangeable rig supports and associated method are disclosed which utilize rig supports to hold one or more fly fishing rigs.

### BACKGROUND

The present invention is related to fly fishing and, more particularly, to advanced apparatus, system and methods for holding fly fishing rigs that are ready for connection to leader line.

Fly fishing involves casting one or more artificial flies with a fishing line into a river, stream or body of water in order to entice fish to get caught by the fly. The artificial flies have hooks which catch in the fishes mouth and the fisherman then reals or pulls in the fish with the fishing line. The fishing line in fly fishing differs from other types of fishing sports in that it usually includes a fly line, which is a relatively larger line, that floats; a tippet line which is a fine, typically monofilament line which is made to be hard to see by the fish; and a leader line connected between the fly line and the tippet and which typically tapers in diameter from a size similar to the fly line to a size similar to the tippet line. Typically the fly line, leader line and tippet line are connected to a real and pole, and various different rigs are attached and removed from the tippet line while fishing. The rigs used in a particular fishing trip can depend on what has previously worked, on what sort of bugs are currently in the water and/or what the fish seem to be biting on at the time.

Fly fishing rigs are arrangements that can include one or more artificial flies and can include a strike indicator. Some artificial flies are dry flies, which are made to float on the water, and some artificial flies are wet flies, which are made to sink into the water. The flies are usually made to imitate bugs at various stages of development. A fly fishing rig can include a two flies, such as a dry fly and a wet fly, connected to one another using a rig tippet. The rig tippet can be the same type of tippet used for the connection to the leader line, or can be different. In the case of a rig having a dry fly and a wet fly, the tippet line connected to the leader line is typically attached to the dry fly so that the dry fly floats and also serves to indicate strikes as well as to attract fish. A strike indicator can be attached to, or can be part of a fly fishing rig to let the fisherman see when a fish has taken a fly. The rig tippet between the flies typically ranges in length from 12 inches to 18 inches for typical trout fishing, but can be longer or shorter.

Conventional storage boxes for dropper rigs can damage the rig tippet line connected between the two flies. These boxes store the rigs in a way in which the line is wrapped around a structure which can cause the rig tippet line to permanently have loops in the shape of the structure. These loops in the line then stay in the rig tippet line when fishing with the rig, they can keep the flies too close to one another which can lead to tangles, and can make the rig less natural looking to a fish. These conventional storage boxes also do not separate the rig tippets of one rig from the rig tippets of other rigs. This can lead to the rigs becoming tangled with each other within the box which can cause the fisherman to have to spend valuable fishing time untangling several of the rigs in order to select and remove one for fishing.

These conventional storage boxes can also damage the line by rubbing or abrading the line as the box is opened and closed. These damages lines are then more susceptible to breaking when a fish is caught. Conventional boxes also require the fisherman to keep at least one hand on the box while tying to the rig and removing the rig from the box, which can make both tasks more difficult.

Other conventional fly storage boxes are only configured to store individual flies and not fly fishing rigs. Using one of these conventional storage boxes to store fly fishing rigs can cause the rig leaders to become so tangled with one another that any time potentially saved by pre-make rigs before fishing is lost.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a method and associated apparatus are described for holding fly fishing rigs during fly fishing, the rigs having a tippet connecting first and second flies. In an embodiment, the rig holder comprises a rig support including an end cap on one end and first and second fly holders which are spaced apart from one another along a length of the rig support. The fly holders can be separated by a tippet aligner configured to hold tippets separately from one another when more than one fly fishing rigs are supported by the rig support. A cylindrically shaped shell body can be included having an end closure closing one end of the shell body and having a body opening on the other end of the shell body. The shell body can be configured to receive at least a portion of the rig support within the shell body. A guide shaft can be connected to the end closure of the shell body and can extend within the shell body along a center axis of the shell body from the end closure. The rig support can be configured to move on the guide shaft linearly along the center axis of the shell body and rotationally about the center axis of the shell body. A closed position bias structure cab be included that can operate to bias the rig support in a closed position in which the fly holders and tippet aligner are within the shell body and the rig support end cap engages the shell body opening to produce a water tight seal. A first fly holder bias structure can operate to bias the rig support in a first fly holder access position in which the rig support is positioned along the guide shaft with the second fly holder in the shell body and the first fly holder extends out of the shell body to allow access to flies supported by the first fly holder. A second fly holder bias structure can operate to bias the rig support in a second fly holder access position in which the rig support is positioned along the guide shaft with at least a portion of both the first fly holder and the second fly holder extending out of the shell body to allow access to flies supported by the first and second fly holders. The position biasing of the closed position bias structure, the first fly holder bias structure and the second fly holder bias structure are each sufficient to at least resist gravity to maintain the position of the rig support relative to the shell body regardless of the spatial orientation of the rig holder.

In another embodiment, a fly fishing rig holder is disclosed which includes a cylindrical shell body and a rig support that is configured for insertion into and removal from the shell body. The rig support can include separate fly holders, arranged for holding flies of a rig separate from one another, and a tippet aligner that is configured for aligning a tippet of the rig between the flies of the rig.

In another embodiment, a method is disclosed for producing a fly fishing rig holder to hold a fly fishing rig while a user fishes, the fly fishing rig having a tippet connecting first and second flies. The method includes producing a cylindrically shaped shell body with an end closure closing one end a body opening on the other end. Configuring a rig support to include an end cap on one end, a tippet aligner, and first and second fly holders on opposite sides of the tippet aligner. Configuring the shell body for supporting the rig support while allowing for linear and rotational motion of the rig support within the shell body.

In addition to the example aspects and embodiments described above, further aspects and embodiments will become apparent by reference to the drawings and by study of the following descriptions.

### BRIEF DESCRIPTION OF THE DRAWINGS

FIG. 1 is an illustration of a fly fishing rig holder in accordance with the present disclosure.

FIG. 2 is a side view of the fly fishing rig holder with a rig support removed from a shell body.

FIG. 3 is a cross section view of the fly fishing rig holder shown in FIG. 2.

FIG. 4 is a perspective view of a tippet aligner of the rig support shown in FIG. 2.

FIG. 5 is a side view of the fly fishing rig holder with the rig support fully inserted into the shell body.

FIG. 6 is a cross section view of the fly fishing rig holder shown in FIG. 5.

FIG. 7 is a side view of the fly fishing rig holder in a first fly holder access position with the rig support extending partially from the shell body.

FIG. 8 is a cross section view of the fly fishing rig holder shown in FIG. 7.

FIG. 9 is a side view of the fly fishing rig holder in a second fly holder access position with the rig support extending out of the shell body.

FIG. 10 is a cross section view of the fly fishing rig holder shown in FIG. 9.

FIG. 11 is a cross section view of the fly fishing rig holder with a closed position bias structure biasing the rig holder in a closed position.

FIG. 12 is a detail of certain components of the closed position bias structure shown in FIG. 11.

FIG. 13 is a cross section view of the fly fishing rig holder with a closed position bias structure releasing the bias of the rig holder from the closed position.

FIG. 14 is a detail of certain components of the closed position bias structure shown in FIG. 13.

FIG. 15 is a perspective view of the fly fishing rig holder in the first fly holder access position having a shoulder sling and a fishing rod holder.

FIG. 16a-16c are perspective views of the fly fishing rig holder with the shoulder sling and fishing rod holder in the second fly holder access position.

FIG. 17 is a perspective view of the fly fishing rig holder with a fishing rod holder holding a fishing rod.

FIGS. 18a-18h are side view of different embodiments of the rig support of the fly fishing rig holder.

FIG. 19 is a method for producing a fly fishing rig holder to hold fly fishing rigs while fishing.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the principles taught herein may be applied to other embodiments. Thus, the present invention is not intended to be limited to the embodiments shown, but is to be accorded the widest scope consistent with the principles and features described herein including modifications and equivalents, as defined within the scope of the appended claims. It is noted that the drawings are not to scale and are diagrammatic in nature in a way that is thought to best illustrate features of interest. Descriptive terminology may be adopted for purposes of enhancing the reader's understanding, with respect to the various views provided in the Figures, and is in no way intended as being limiting.

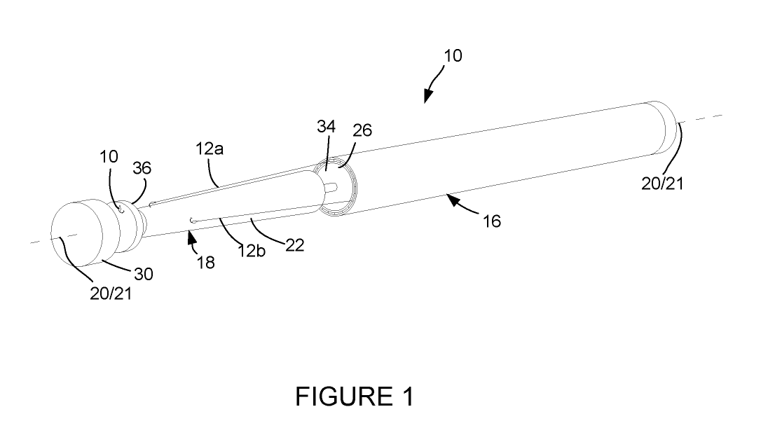

Attention is now directed to the Figures wherein like items may refer to like components throughout the various views. FIG. 1 is a perspective view of a fly fishing rig holder 10 which can hold fly fishing rigs 12a and 12b and others. The rigs are held such that the rig tippets are in a relatively straight line or with only slight bends. This prevents the rig tippets from becoming permanently deformed with shapes, like loops, that can negatively impact the use of the rig. Rig holder 10 can also hold individual flies, such as artificial fly 14. Rig holder 10 can include a shell body 16 and a rig support 18 by which rigs, such as rigs 12a and 12b can be supported. The rig support is configured for insertion into and removal from the shell body. The shell body defines a center axis 20 and the rig support defines a center axis 21. When the rig support is at least partially inserted into the shell body, center axis 20 and center axis 21 are co-linear and shell body and the rig support are linearly movable relative to one another along center axis 20/21 and rotationally, relative to one another, about center axis 20/21.

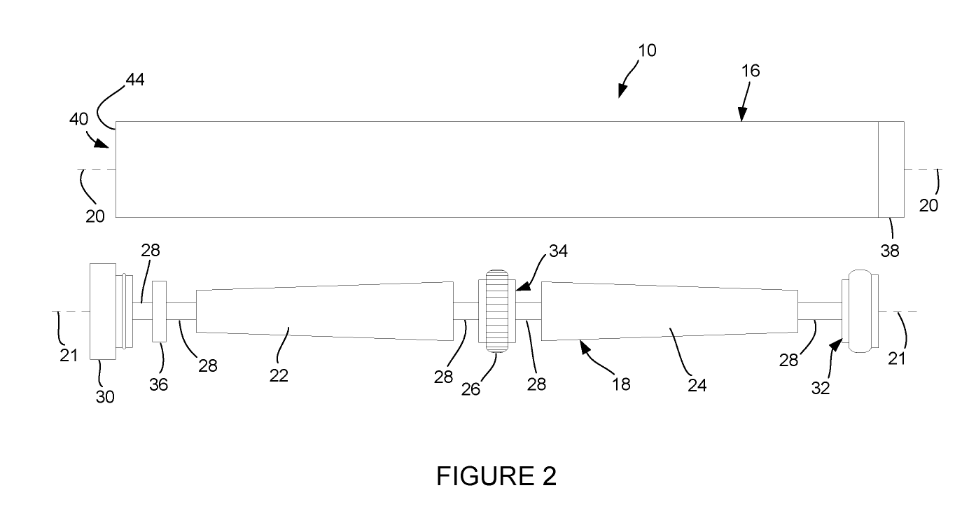

Turning now to FIG. 2, the rig support 18 can be removed from and reconnected to the shell body 16. Rig support 18 includes fly holders 22 and 24 and a tippet aligner 26. The fly holders can be made from a foam, cork or other material into which the fish hooks of the artificial flies can be inserted and removed. The fly holders can hold the fly where the hook is inserted while still allowing the fly to be removed by hand. The fly holders can be connected to a rig support shaft 28 and can be separated along the length of the rig support shaft from one another. The tippet aligner can also be connected to the rig support shaft and can be positioned between fly holders 22 and 24. The rig support can also include an end cap 30 connected to one end of the rig support shaft and an end support structure 32 connected to an opposite end of the rig support shaft. The rig support can include an intermediate support structure 34 positioned between the end cap and the end ring structure and the tippet aligner can be part of the intermediate support structure. The rig support can also include a magnetic fly holder 36, for holding individual flies, which can be connected to the rig support shaft. The magnetic fly holder can be toroid shaped or other shape that allows the holder to be inserted into the shell body. Shell body 16 can have a cylindrical shape with an end closure 38 closing one end of the shell body and a body opening 40 at an opposite end 44 of the shell body.

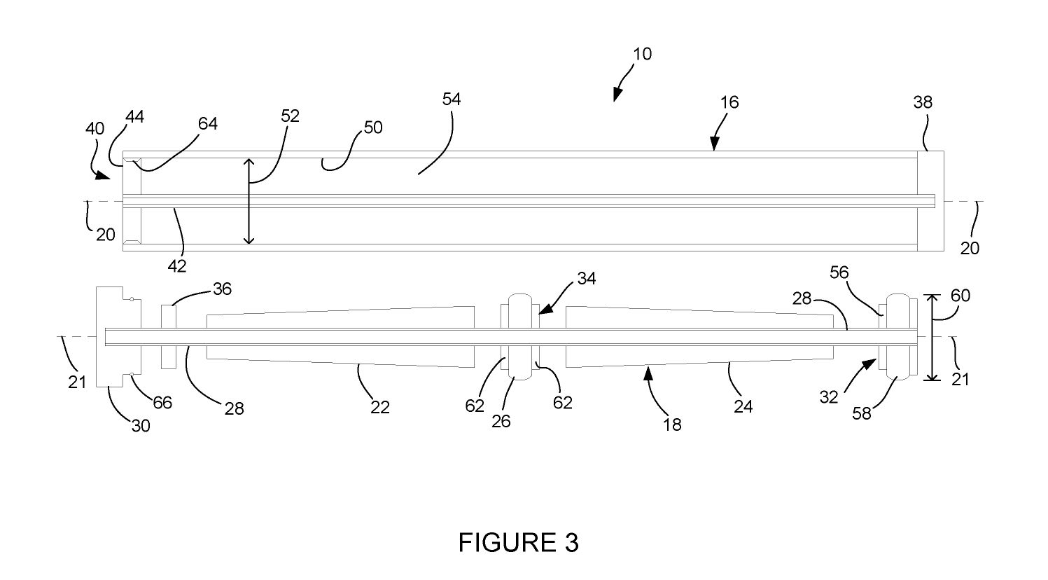

Turning now to FIG. 3, sectional views are shown of the shell body and rig support of the rig holder 10 of FIG. 2. A guide shaft 42 can be connected to the end closure 38 and can extend within the shell body along the center axis 20, from the end closure. The rig support shaft 28 can be tubing with a round cross section and an inner diameter that fits around an outer diameter of the guide shaft 42. This allows the rig support shaft to fit over the guide shaft and to slide linearly along the center axis of the shell body and around the center axis of the shell body. The guide shaft can be hollow or solid and the guide shaft and rig support shaft can be made from a metal such as aluminum, a plastic material, carbon fiber, or other material that can provide sufficient structural rigidity.

The shell body can have an inner surface 50 with an inner diameter 52 that defines a shell body chamber 54. The end support structure 32 can include an end support body 56 and an end support ring 58 that has an outer diameter 60 which allows the ring 58 to contact the inner surface 50 and slide within the shell body chamber with a small degree of resistance. The intermediate support structure 34 can include an intermediate support body 62 and the tippet aligner 26 which can be shaped like a ring and can extend around the intermediate support body. The tippet aligner can have an outer diameter which can be the same as the outer diameter 60 of the end support ring and which can allow the tippet aligner to contact the inner surface 50 of the shell body chamber. The end support ring and the tippet aligner can be made from an elastic material and can be configured to be slightly compressed when inserted in the shell body in contact with the inner surface 50.

A fisherman can have multiple rig supports which can be used at different times with a single shell body. Different rig supports can have different fly rigs attached. A particular rig support could have fly rigs which work well for a particular stream, while another rig support could have fly rigs which work well for a different stream. Other rig supports could be loaded with fly rigs related to a season or a particular hatch. Using the rig holder described herein, the fisherman can select any of these particular rig supports (or others) and can insert the selected rig support into the shell body. This way the fisherman can quickly change the set of fly rigs available to them while fishing. The rig holders can be pre-loaded by the fisherman before the fishing trip, or could be preloaded by a fishing shop or outfitter that is local or has knowledge about the place where the fisherman intends to fish. Because a fisherman can have multiple rig supports which can be loaded with different rigs, the fisherman can quickly select and utilize a set of rigs without wasting fishing time loading and removing rigs while fishing.

The cap 30 of the rig supports can be removably connected to the rig support shaft 28 and the individual rig supports can utilize a single cap at different times. This can reduce the cost of the rig supports which can make it more affordable for a fisherman to have multiple rig supports. The cap can be threaded onto the rig support shaft or can be removably attached in another way.

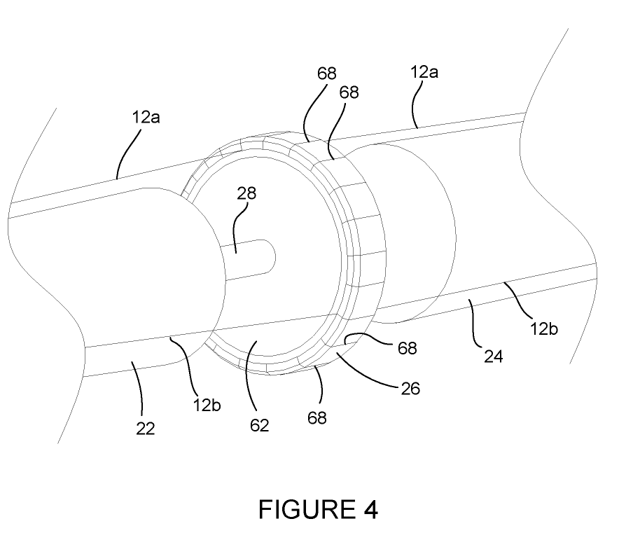

Turning now to FIG. 4, the tippet aligner 26 is shown in a perspective view along with intermediate support body 62, a portion of rig support shaft 28, portions of fly holders 22 and 24, and the rig tippets of fly rigs 12a and 12b. Tippet aligner 26 can have slots 68 which receive the rig tippets and which hold the rig tippets relatively inward toward the intermediate support body 62. These slots can be used to organize the rigs so that the rig tippets of one rig cannot be tangled with the rig tippet of another rig. The slots also keep the rig tippets away from the outer edge of the tippet aligner which keeps the rig tippets from contacting the inner surface of the shell body and prevents the rig tippets from being damaged by the shell body when the rig support is moved relative to the shell body. The tippet aligner can be made from an elastic material that can be compressed as the rig tippet is inserted in a slot 68 and which provides at least some resistance to the removal of the rig tippet from the slot 68 to thereby hold the rig tippet in the slot.

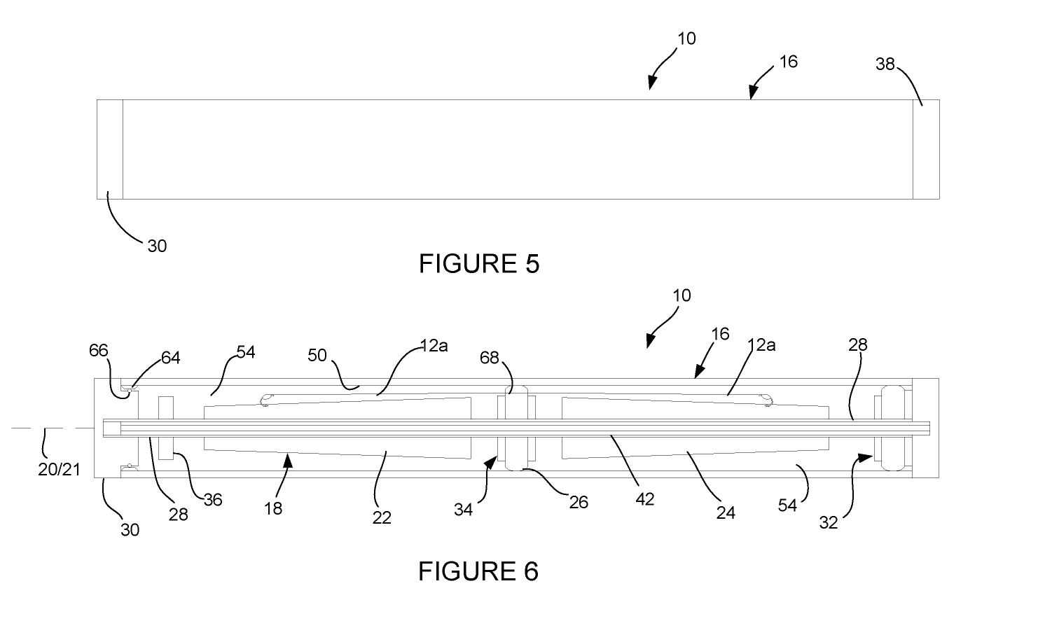

Turning now to FIGS. 5 and 6, the fly fishing rig holder is shown with the rig support fully inserted in the shell body, which can be referred to as a closed position. FIG. 5 shows the rig holder in an elevation view and FIG. 6 shows a cut away view of the rig holder. The shell body can include a bias ring 64 which can be positioned at the body opening 40 (FIG. 3) and which can provide a reduction in the inner diameter of the shell body at the body opening. The end cap 30 of the rig support can include an elastic seal 66 such as an O-ring which can be used to engage the bias ring 60 to make a water tight seal. When the rig holder is in the closed position, the end cap 30 engages the shell body opening to produce the water tight seal. In an embodiment, the bias ring 64 can be considered to be part of the body opening of the shell body. This water tight seal prevents water from entering the shell body chamber 54 and keeps the fly rigs dry even when the fly rig holder 10 is fully submerged in water.

The elastic seal 66 can be slightly compressed against the bias ring when the rig holder is in the closed position, which can provide an increased resistance to movement of the rig support relative to the shell body relative to when the bias ring and elastic seal are not in contact. This increase in resistance can be referred to as a bias, and the bias ring and elastic seal can bias the rig holder in the closed position.

As can be seen in FIG. 6, the tippet aligner 26 holds the rig tippet of rig 12a in a tippet aligner slot and maintains the rig tippet at a distance from the inner surface of the shell body. This prevents the rig tippet from contacting the inner surface of the shell body to prevent damage to the rig tippet, especially during movement of the rig support relative to the shell body. Also, as shown in FIG. 6, the rig is held in substantially a straight line which keeps the rig tippet from permanently deforming into a shape that can cause tangles, line weakness or an unnatural appearance to fish. Applicants recognize that holding the rig with the tippet in any sort of loop should be avoided to prevent the rig tippet from permanently taking on a loop shape which can cause tangles. The embodiment shown in FIG. 6 holds the rigs with only a slight bend in the rig tippet. Other embodiments may hold the rigs with a larger bend or with a smaller bend. These embodiments can include bends of less than 45 degrees in the rig tippet which can still prevent tangling.

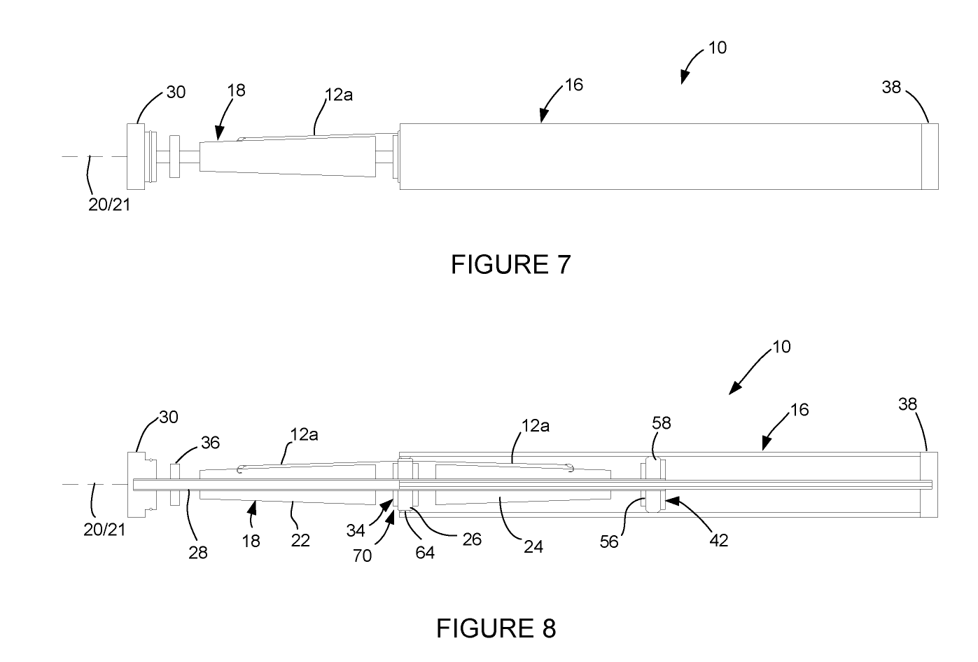

Turning now to FIGS. 7 and 8, the fly fishing rig holder is shown with the rig support partially extended from the shell body. This position can be referred to as a first fly holder access position since the fisherman can access the flies connected to the fly holder 22 while the rig holder still holds and separates the rig tippets with the tippet aligner, and the other of the flies connected to the fly holder 24. In the first fly holder access position, the fisherman can remove a fly from the fly holder 22 and can tie the fishing line leader to the fly. This action can be accomplished while the rig holder still holds the rig tippet and the second fly of the rig. The fisherman can also leave the fly on fly holder 22 until the fishing line leader is connected to the fly.

As shown in FIG. 8, when the fly holder is in the first fly holder position the tippet aligner is in contact with the bias ring 64. Since the bias ring 64 has a smaller inner diameter than the inner surface of the shell body the tippet aligner compresses slightly to fit within the bias ring. Since the fitment between the tippet aligner and the bias ring is tighter than the fitment between the tippet aligner and the inner surface of the shell body, the rig support has more resistance to movement relative to the shell body in this position. This greater resistance to relative movement can be considered to be a bias in this position with the bias ring and the tippet aligner serving to cooperate as a first fly holder bias structure 70.

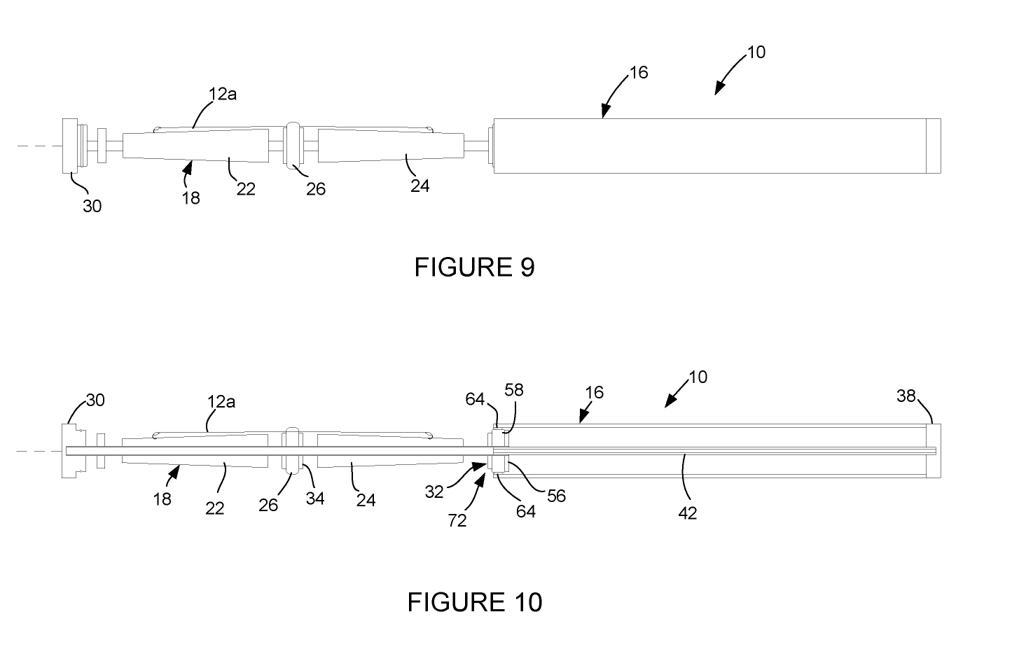

Turning now to FIGS. 9 and 10, the fly fishing rig holder is shown with the rig support fully extended from the shell body while still supported by the shell body. This position can be referred to as a second fly holder access position. In the second fly holder access position the fisherman can access the flies connected to the fly holder 24 and can completely remove the rigs from the rig support, 18 including removing rig tippets from the rig tippet aligner 26.

As shown in FIG. 10, when the fly holder is in the second fly holder position the end support ring is in contact with the bias ring 64. The end support ring compresses slightly to fit within the bias ring because the bias ring 64 has a smaller inner diameter than the inner surface of the shell body. Since the fitment between the end support ring and the bias ring is tighter than the fitment between the end support ring and the inner surface of the shell body, the rig support has more resistance to movement relative to the shell body in this position. This greater resistance to relative movement can be considered to be a bias in this position with the bias ring and the end support ring serving to cooperate as a second fly holder bias structure 72. Also as can be seen from FIG. 10, the guide shaft 42 remains inside of the rig support shaft 28 toward the end 44 of the shell body, which at least partially maintains the support of the rig support with the shell body.

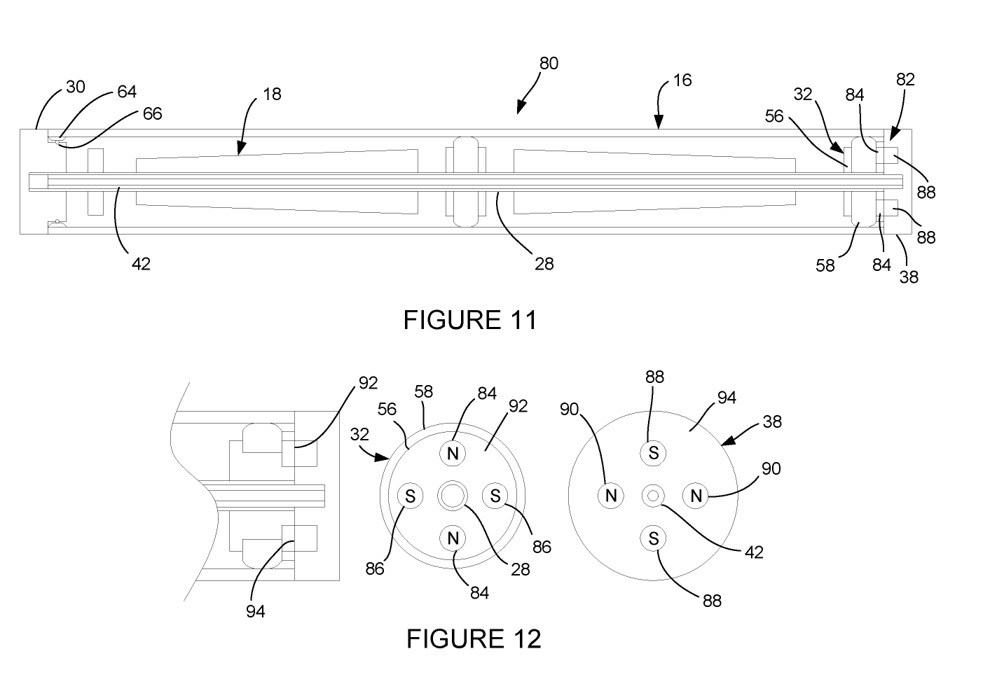

Turning now to FIGS. 11 and 12, a rig holder 80 having a closed position bias structure 82 is shown. Rig holder 80 is shown in a closed position in which the end cap 30 is engaged with the opening of the shell body and the elastic seal 66 is in contact with the bias ring 64. The closed position bias structure can include magnets 84 and 86 incorporated into end support structure 32 and magnets 88 and 90 incorporated into end closure 38 of the shell body 16. In the closed position, an end surface 92 of the end support structure 32 can contact an end surface 94 of the end closure 38. Magnets 84 and 88 can be arranged so that there is an attractive force between them in the closed position; and magnets 86 and 90 can be arranged so that there is an attractive force between them in the closed position. These attractive forces can bias the rig support 18 in the shell body in the closed position and can maintain the water tight seal at the end cap 30. In embodiment, magnets 84 and 86 can have different magnetic pole types at the end surface 92; magnets 88 and 90 can have different magnetic pole types at end surface 94; and magnets 84 and 90 can be the same pole types and magnets 86 and 88 can be the same pole types.

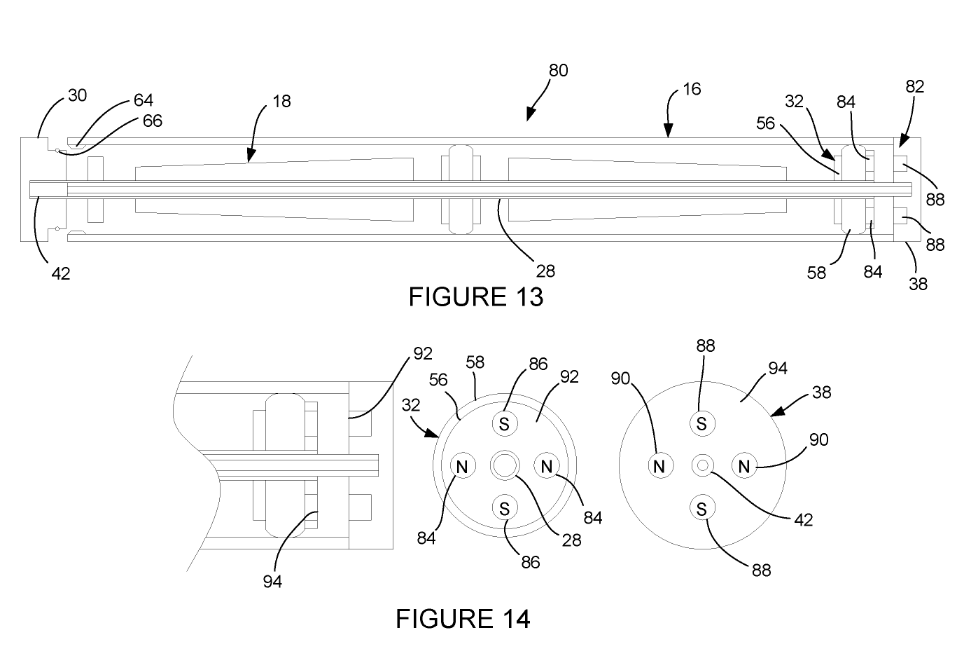

Turning now to FIGS. 13 and 14, the rig support 18 can be rotated about the center axis 20/21 relative to the shell body 16 by 90 degrees. This can move the magnets 86 into alignment with magnets 88 and magnets 84 into alignment with magnets 90 which causes the magnets to repel one another. The end support structure 32 of the rig support is moved away from the end closure 38 of the shell body and the rig support moves linearly within the shell body and partially extends from the shell body. The movement also disengages the end cap 30 from the shell body. Rotation of the rig support relative to the shell body can be accomplished by grasping the end cap with one hand and the shell body with the other hand and twisting them relative to one another. Once the end cap has disengaged the shell body, the rig support can be moved to the first fly holder access position, the second fly holder access position, or can be removed entirely from the shell body.

In an embodiment, magnets 84 and 86 can have one magnetic pole type (either North or South) at the end surface 92, and magnets 88 and 90 can have the opposite magnetic pole at the end surface 94. In this embodiment, however, there will not be an assisted opening force when the rig support 18 is rotated about the center axis of the shell body 16.

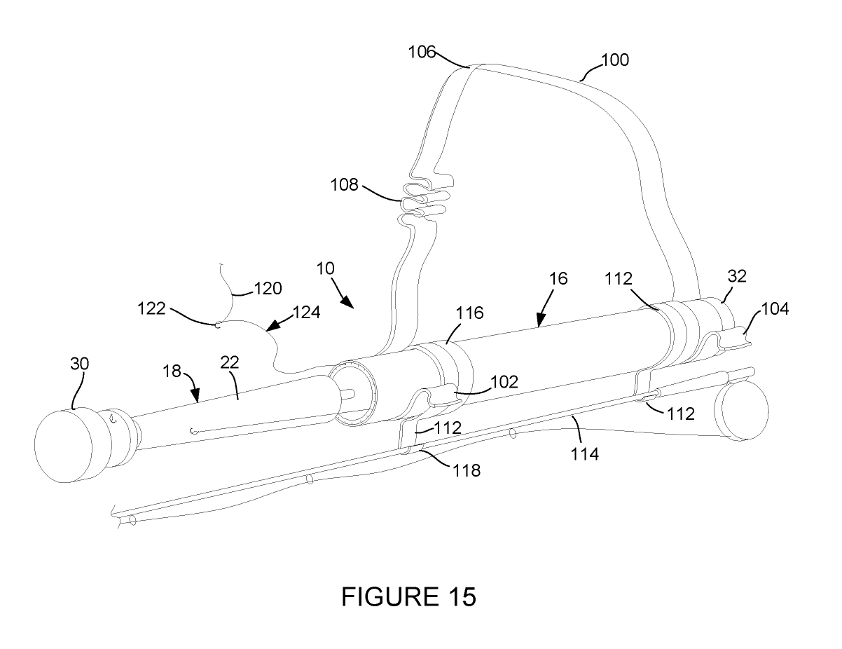

Turning now to FIG. 15, fly fishing rig holder 10 is shown having the rig support 18 extended partially from the shell body 16 to the first fly holder position. The rig holder can include a rig holder sling 100 which can be connected to the shell body and arranged to loop over the fisherman's shoulder to support the rig holder. The shoulder sling can include clips 102 and 104 on either end to attach and detach the sling to the shell body.

The rig holder can be supported by the shoulder sling so that the rig support is positioned substantially horizontal to the ground. The rig holder can include a bent section 106 that can hold a shape and which can be used to keep the sling on the shoulder. The sling can also hold the rig holder in a generally vertical position, which is out of the way when fishing, by positioning the sling portion toward either end of the shell body over the shoulder. The shoulder sling can include an adjustment portion 108 which can be extended or shortened to make the sling longer or shorter, respectively. The position biasing of the closed position bias structure, the first fly holder bias structure and the second fly holder bias structure are each sufficient to at least resist gravity to maintain the position of the rig support relative to the shell body regardless of the spatial orientation of the rig holder.

Rig holder 10 can also include a rod holder 112 which can be connected to the shell body and can be arranged for holding a fishing rod 114. The rod holder can be part of the sling or can be separate. In an embodiment, the rod holder includes a helical shape 116, which can be wrapped around the shell body, and a support 118, such as a hook which can support the rod. The rod holder can be used to support the rod using the shoulder sling so that the fisherman can have both hands free to tie a tippet line 120 to a fly 122 of a rig 124.

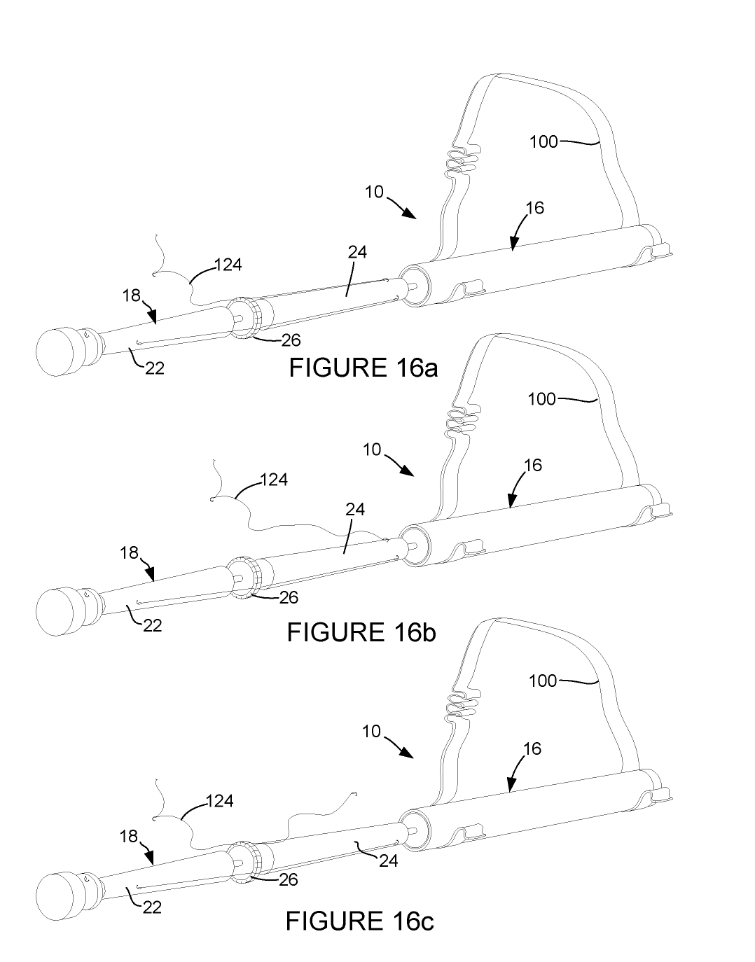

Turning now to FIGS. 16a, 16b and 16c, fly fishing rig holder 10 is shown having the rig support 18 extended fully from the shell body 16 to the second fly holder position. In this position the sling 100, (if included) can support the rig holder from the fisherman's shoulder. The rigs, such as rig 124, are fully exposed and can be easily removed from the rig support. The first fly of the rig can be removed from fly holder 22, as shown in FIG. 16a, if not already removed when the rig holder was in the first fly holder position (FIG. 15). The rig tippet can be removed from the tippet aligner simply by pulling the tippet from the slot with sufficient force to overcome the holding force of the slot. The tippet can be removed from the tippet aligner either before the second fly of the rig is removed from the fly holder 24, as shown in FIG. 16b, or after the second fly of the rig is removed from the fly holder 24, as shown in FIG. 16c.

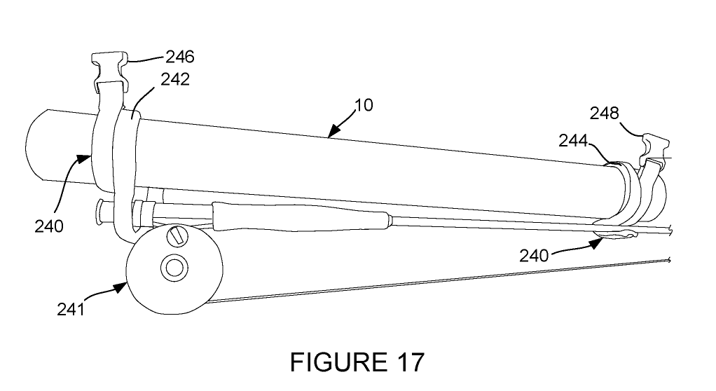

Turning now to FIG. 17, another embodiment of a fishing rod holder 240 is shown connected to fly fishing rig holder 10 for holding a fishing rod 241. Rod holder 240 can include two parts, a reel end holder 242 and a rod shaft holder 244. The rod holder can be made from a material such as polycarbonate, lexan, metal or other material which can hold a shape while supporting the fishing rod and reel. The rod holder can include a cover material which can be nylon webbing or other material that can provide a friction resistance to keep the rod holder positioned on the rig holder and which can keep the rod from sliding in the rod holder. The rod holder can also have a resilience which can allow the rod holder to maintain position on the rig holder by constricting around the outside surface of the rig holder. The rod holder can include clips 246 and 248 which can be clipped to a strap (not shown).

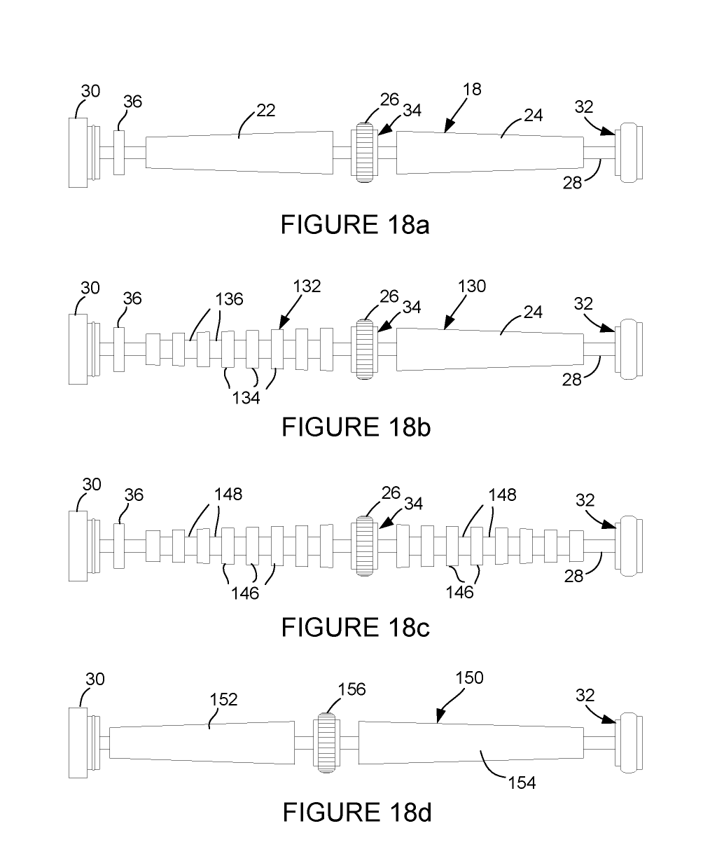

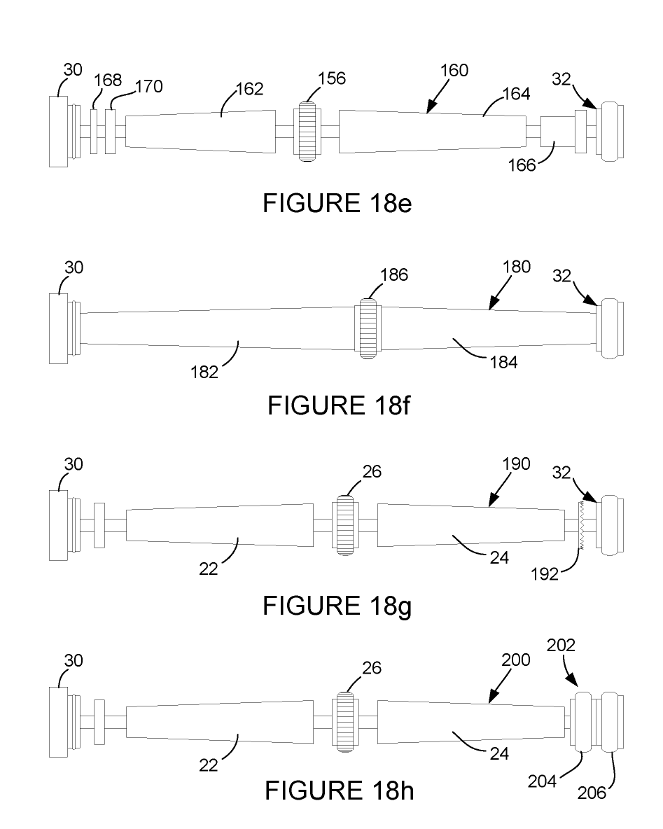

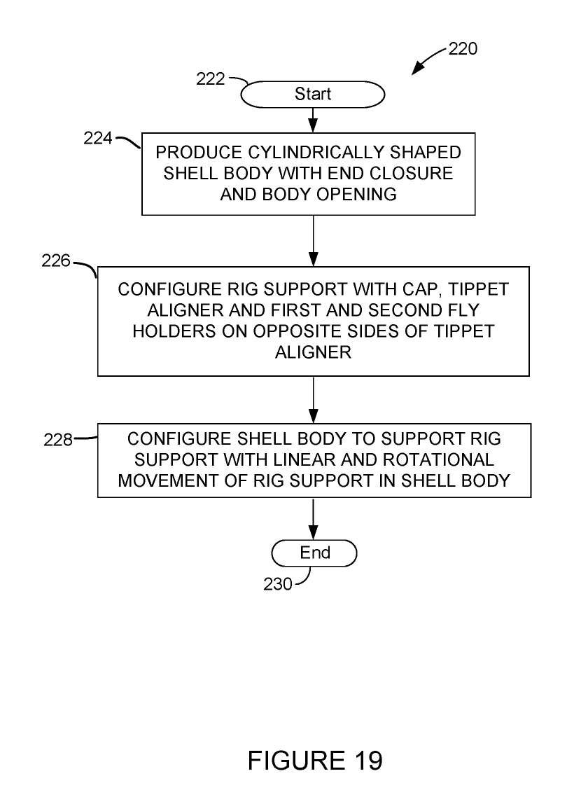

Turning now to FIG. 18a-18g in which several different configurations of rig supports are shown which can be used in a single shell body. Other rig supports may have larger or smaller diameters and/or longer or shorter lengths. Rig support 18 (FIG. 18a) is discussed above and can serve as a reference for comparison of the features of the other rig supports. A rig support 130, FIG. 18b, can have a fly holder 24, end support structure 32, and tippet aligner 26 similar to rig support 18. Rig support 130 can have a fly holder 132 that has annularly shaped sections 134 that extend from a core 136. Fly holder 132 can provide a different surface structure for attaching flies which may be preferred by some fishermen. A rig support 140, FIG. 18c, can include fly holders 142 and 144 which both have annularly shaped sections 146 and cores 148.

A rig support 150, FIG. 18d, can include fly holders 152 and 154 which are separated by a tippet aligner 156. In this embodiment, fly holder 154 is slightly longer than fly holder 152 and the tippet aligner is located closer to the end cap 30 than to end support structure 32. The embodiment shown in FIG. 18d also does not include a magnetic fly holder. A rig support 160, FIG. 18e, can include fly holders 162, 164, and 166. Although shown in FIG. 18e with two fly holders on the same side of the tippet aligner as the end support structure 32, the two fly holders can be on the same side as the end cap 30. Also shown in this embodiment, the rig support can include one or more spools 168 and 170 of tippet.

A rig support 180, FIG. 18f, includes fly holders 182 and 184 which are on opposite sides of a tippet aligner 186. In the embodiment shown, fly holder 182 can extend all the way from the tippet aligner to the end cap 30, and fly holder 184 can extend all of the way from the tippet aligner to the end support structure 32. A rig support 190, FIG. 18g, includes a tippet wrap 192. Tippet wrap 192 can be used to change the direction of the rig tippet so that rigs that are longer than the rig support can be stored in the rig support 190. The longer rig tippets can be hooked around the tippet wrap and the second fly can then be hooked onto either fly holder 24, or can be extended back past the tippet aligner to fly holder 22. In the latter case, the rig tippet can be held in the tippet aligner using the same slot or another slot. In another embodiment, the rig support can include one or more pins 194 which can be inserted into the fly holder and which can also be used for producing a substantially 180 degree turn in the rig tippet.

A rig support 200, FIG. 18h, includes an end support structure 202 that has end support rings 204 and 206. Having the support rings 204 and 206 spaced apart from one another can give end support structure 202 a greater support than a single end support ring, especially when the rig support is fully extended from the shell body. The support ring 204 can cooperate with the bias ring 64 (FIG. 7) to bias the rig support in the second fly holder access position where the fisherman has access to the fly holder 24.

Turning now to FIG. 18, a method 220 is shown for producing a fly fishing rig holder to hold a fly fishing rig while a user fishes. The fly fishing rigs having a tippet connecting first and second flies. Method 220 begins at 222 and proceeds to 224 where a cylindrically shaped shell body is produced with an end closure closing one end and a body opening on the other end. Method 220 then proceeds to 226 where a rig support is configured to include an end cap on one end, a tippet aligner, and first and second fly holders on opposite sides of the tippet aligner. Method 220 then proceeds to 228 where the shell body is configured for supporting the rig support while allowing for linear and rotational movement of the rig support within the shell body. Method 220 then proceeds to 230 where the method ends.

Various embodiments of systems and techniques are disclosed herein in which fly fishing rigs can be pre-made and stored in a rig holder for use during a fishing trip. Rig supports can be pre-loaded with rigs for a particular river, hatch, season or other factor related to the types of rigs used for a particular fishing trip or time. Different rig supports can be loaded with different types of rigs and the different rig supports can be inserted into the same shell body depending on which rigs the fisherman wants to use. The systems and techniques described herein provide a convenient and time saving way to use fly fishing rigs while fly fishing. Applicants submit that apparatus, systems and methods according to the present disclosure provide sweeping and heretofore unseen benefits that are not recognized by prior art.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A fly fishing rig holder for holding fly fishing rigs having a tippet connecting first and second flies, the rig holder comprising:
a rig support including an end cap on one end and first and second fly holders which are spaced apart from one another along a length of the rig support and which are separated by a tippet aligner configured to hold tippets separately from one another when more than one fly fishing rigs are supported by the rig support;
a cylindrically shaped shell body having an end closure closing one end of the shell body and having a body opening on the other end of the shell body, the shell body configured to receive at least a portion of the rig support within the shell body;
a guide shaft connected to the end closure of the shell body and extending within the shell body along a center axis of the shell body from the end closure, the rig support configured to move on the guide shaft linearly along the center axis of the shell body and rotationally about the center axis of the shell body,
a closed position bias structure operable to bias the rig support in a closed position in which the fly holders and tippet aligner are within the shell body and the rig support end cap engages the shell body opening to produce a water tight seal,
a first fly holder bias structure operable to bias the rig support in a first fly holder access position in which the rig support is positioned along the guide shaft with the second fly holder in the shell body and the first fly holder extending out of the shell body to allow access to flies supported by the first fly holder; and
a second fly holder bias structure operable to bias the rig support in a second fly holder access position in which the rig support is positioned along the guide shaft with at least a portion of both the first fly holder and the second fly holder extending out of the shell body to allow access to flies supported by the first and second fly holders, and wherein the position biasing of the closed position bias structure, the first fly holder bias structure and the second fly holder bias structure are each sufficient to at least resist gravity to maintain the position of the rig support relative to the shell body regardless of the spatial orientation of the rig holder.

2. The rig holder as defined in claim 1, wherein the tippet aligner includes grooves configured to hold the tippet connected between the flies when one of the flies is supported by the first fly holder and the other of the flies is supported by the second fly holder, the grooves configured to hold the tippet such that the tippet is protected against abrasion when the rig support is moved on the guide shaft.

3. The rig holder as defined in claim 1, wherein the tippet aligner forms part of the first fly holder bias structure.

4. The rig holder as defined in claim 1, wherein the closed position bias structure includes magnets in the end closure of the shell body and magnets in the rig support.

5. The rig holder as defined in claim 4, wherein the end closure magnets and the rig support magnets are arranged to attract one another in one rotational position of the rig support relative to the shell body and to repel one another in another rotational position of the rig support relative to the shell body.

6. The rig holder as defined in claim 4, wherein the magnets in the end closure and the rig support have sufficient attractive force to maintain the water tight seal between the rig support end cap and the shell body opening in the closed position.

7. The rig holder as defined in claim 1, wherein the fly holders are positioned relative to one another such that a fly rig can be held with the tippet in a single substantially straight line.

8. The rig holder as defined in claim 1, further comprising:
a sling having a first and second ends connected to the shell body in a spaced apart relationship, the sling having a length sufficient to allow a user to place a portion of the sling over a shoulder to support the shell body from the shoulder; and
a rod holder connected to the shell body and configured for holding a fishing rod substantially parallel to the center axis of the shell body such that the shell body and the fishing rod can be supported by the user's shoulder without relying on the user's hands.

9. The rig holder as defined in claim 8, wherein the rod holder includes a helical shape for connecting the rod holder to the shell body.

10. A method for producing a fly fishing rig holder to hold a fly fishing rig while a user fishes, the fly fishing rig having a tippet connecting first and second flies, the method comprising:
producing a cylindrically shaped shell body with an end closure closing one end and a body opening on the other end;
configuring a rig support to include an end cap on one end, a tippet aligner, and first and second fly holders on opposite sides of the tippet aligner; and
configuring the shell body for supporting the rig support while allowing for linear and rotational motion of the rig support within the shell body.

11. The method for producing the fly fishing rig holder as defined in claim 10, further comprising:
configuring the shell body opening and the rig support end cap for engagement in a water tight seal.

12. The method for producing the fly fishing rig holder as defined in claim 11, further comprising:
producing a closed position bias for biasing the shell body opening and the rig support end cap together in the water tight seal.

13. The method for producing the fly fishing rig holder as defined in claim 12, further comprising:
producing a first fly holder bias for biasing the rig support in a position relative to the shell body which exposes the first fly holder while confining the second fly holder within the shell body.

14. The method for producing the fly fishing rig holder as defined in claim 13, further comprising:
producing a second fly holder bias for biasing the rig support in a position relative to the shell body which exposes the first and second fly holders while the shell body supports the rig support.

15. The method for producing the fly fishing rig holder as defined in claim 10, further comprising:
connecting a sling to the shell body in at least two positions for supporting the rig holder with a shoulder of a user; and
configuring a rod holder for selectively holding a fishing rod adjacent to the shell body such that the fishing rod is at least generally aligned parallel with a center axis of the shell body.

16. The method for producing the fly fishing rig holder as defined in claim 10, wherein configuring the rod holder includes forming at least a part of the rod holder into a helical shape.

17. A fly fishing rig holder comprising:
a cylindrical shell body;
a rig support that is configured for insertion into and removal from the shell body, the rig support including separate fly holders, arranged for holding flies of a rig separate from one another, and a tippet aligner configured for aligning a tippet of the rig between the flies of the rig.

18. The fly fishing rig holder as defined in claim 17, wherein the fly holders and tippet aligner are configured for holding the rigs radially about a center axis of the shell body.

19. The fly fishing rig holder as defined in claim 18, wherein the tippet aligner is configured to hold tippets of separate rigs spaced apart from one another.

20. The fly fishing rig holder as defined in claim 17, further comprising:
a guide connected to the shell body and configured for guiding the rig support in linear movements along a center axis of the shell body and rotation movements about the center axis of the shell body; and
a bias for biasing the rig support in a position in which at least one of the fly holders is exposed.
